(19) United States
(12) Patent Application Publication
(10) Pub. No.: US 2016/0014646 A1
(43) Pub. Date: Jan. 14, 2016

(54) FAST RADIO LINK RECOVERY FOR LTE NETWORKS

(71) Applicants: Candy YIU, Portland, OR (US); Yujian ZHANG, Beijing, 11 (CN); Youn Hyoung HEO, San Jose, CA (US)

(72) Inventors: Candy YIU, Portland, OR (US); Yujian ZHANG, Beijing, 11 (CN); Youn Hyoung HEO, San Jose, CA (US)

(21) Appl. No.: 14/773,295

(22) PCT Filed: Mar. 24, 2014
(86) PCT No.: PCT/US14/31633

§ 371 Date: Sep. 4, 2015

Related U.S. Application Data
(60) Provisional application No. 61/808,597, filed on Apr. 4, 2013.
(60) Provisional application No. 61/829,968, filed on May 31, 2013.

(51) Int. Cl. H04W 36/00; H04B 17/318

(52) U.S. Cl. CPC H04W 36/0055; H04B 17/318

(57) ABSTRACT

Embodiments of the present disclosure are directed toward devices and methods for fast radio link recovery in cellular networks. In one embodiment, the signal strength of the serving cell is compared to the signal strength of a target cell, and a radio link failure (RLF) timer is terminated or shortened based on the comparison. Alternatively, a second shorter timer may be used as opposed to modifying the current timer. In some embodiments, the modification of RLF timers may be triggered by the start of a measurement trigger timer. This may allow a user equipment to more quickly establish a connection with a target cell in situations where radio link failure or handover failure are likely to occur. In some instances, the parameters for terminating or shortening the radio link failure timer, or starting an additional timer, may be provided to the user equipment by a network.

### CROSS REFERENCE TO RELATED APPLICATION

The present application claims priority to U.S. Provisional Patent Applications No. 61/808,597, filed Apr. 4, 2013, entitled “Advanced Wireless Communication Systems and Techniques,” and No. 61/829,968, filed May 31, 2013, entitled “Advanced Wireless Communication Systems and Techniques, the entire disclosure of each of which is hereby incorporated by reference in its entirety.

### FIELD

Embodiments of the present disclosure generally relate to the field of cellular networks, and more particularly, to techniques, and apparatuses employing techniques, for fast recovery of radio links in cellular networks.

### BACKGROUND

When a user equipment (UE) moves from a serving cell to a target cell, a handover process generally takes place to provide a seamless transition without service disruptions. Sometimes this handover process is unsuccessful, resulting in handover failures and potentially in service outages. There are numerous causes of handover failure. Timing of the handover process may be critical because the signal from the serving cell must be strong enough to allow the UE to receive the handover command, while the signal from the target cell must also be strong enough so that the UE can establish a connection with the target cell.

When handover failures occur, the UE may enter a radio link failure (RLF) process and perform an RLF recovery process to re-establish a connection with a serving cell. During the RLF and RLF recovery processes, the UE may experience service outages due to inadequate signal strength from the serving cell. The RLF recovery process may result in the UE establishing a connection with the intended target cell to which a handover process previously failed.

The handover, RLF, and RLF recovery processes may have timers associated with them. It may be necessary for one or more of these timers to expire before the UE may initiate a given process. This may lead to longer service outages in some instances.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 schematically illustrates a network with a user equipment (UE) moving from a serving cell to a target cell in accordance with some embodiments.

FIG. 2 schematically illustrates a radio link failure (RLF) process in accordance with some embodiments.

FIG. 3 schematically illustrates a measurement trigger process in accordance with some embodiments.

FIG. 4 schematically illustrates a connection establishment process in accordance with some embodiments.

FIG. 5 schematically illustrates a fast RLF process in accordance with some embodiments.

FIG. 6 schematically illustrates a fast RLF process utilizing a shortened RLF timer in accordance with some embodiments.

FIG. 7 schematically illustrates a fast RLF process initiated by a trigger event in accordance with some embodiments.

FIG. 8 schematically illustrates a system for implementing RLF processes in accordance with some embodiments.

### DETAILED DESCRIPTION

Embodiments of the present disclosure describe methods and apparatuses for fast radio link recovery in cellular networks. These embodiments are designed to minimize service outages and provide efficient service re-establishment in instances of radio link failure (RLF) or handover failure.

In the following description, various aspects of the illustrative implementations will be described using terms commonly employed by those skilled in the art to convey the substance of their work to others skilled in the art. However, it will be apparent to those skilled in the art that embodiments of the present disclosure may be practiced with only some of the described aspects. For purposes of explanation, specific numbers, materials, and configurations are set forth in order to provide a thorough understanding of the illustrative implementations. However, it will be apparent to one skilled in the art that embodiments of the present disclosure may be practiced without the specific details. In other instances, well-known features are omitted or simplified in order not to obscure the illustrative implementations.

In the following detailed description, reference is made to the accompanying drawings, which form a part hereof, wherein like numerals designate like parts throughout, and in which is shown by way of illustration embodiments in which the subject matter of the present disclosure may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). The description may use the phrases “in an embodiment,” “in embodiments,” or “in some embodiments,” which may each refer to one or more of the same or different embodiments. Furthermore, the terms “comprising,” “including,” “having,” and the like, as used with respect to embodiments of the present disclosure, are synonymous.

The term “coupled with,” along with its derivatives, may be used herein. “Coupled” may mean one or more of the following. “Coupled” may mean that two or more elements are in direct physical or electrical contact. However, “coupled” may also mean that two or more elements indirectly contact each other, but yet still cooperate or interact with each other, and may mean that one or more other elements are coupled or connected between the elements that are said to be coupled with each other. The term “directly coupled” may mean that two or more elements are in direct contact.

As used herein, the term “circuitry” refers to, is part of, or includes hardware components such as an Application Specific Integrated Circuit (ASIC), an electronic circuit, a logic circuit, a processor (shared, dedicated, or group), and/or memory (shared, dedicated, or group) that are configured to provide the described functionality. In some embodiments, the circuitry may execute one or more software or firmware programs to provide at least some of the described functionality.

As used herein, the term “module” may refer to, be part of, or include an Application Specific Integrated Circuit (ASIC), an electronic circuit, a system-on-chip (SoC), a processor (shared, dedicated, or group) and/or memory (shared, dedicated, or group) that execute one or more software or firmware programs, a combinational logic circuit, and/or other suitable components that provide the described functionality.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation

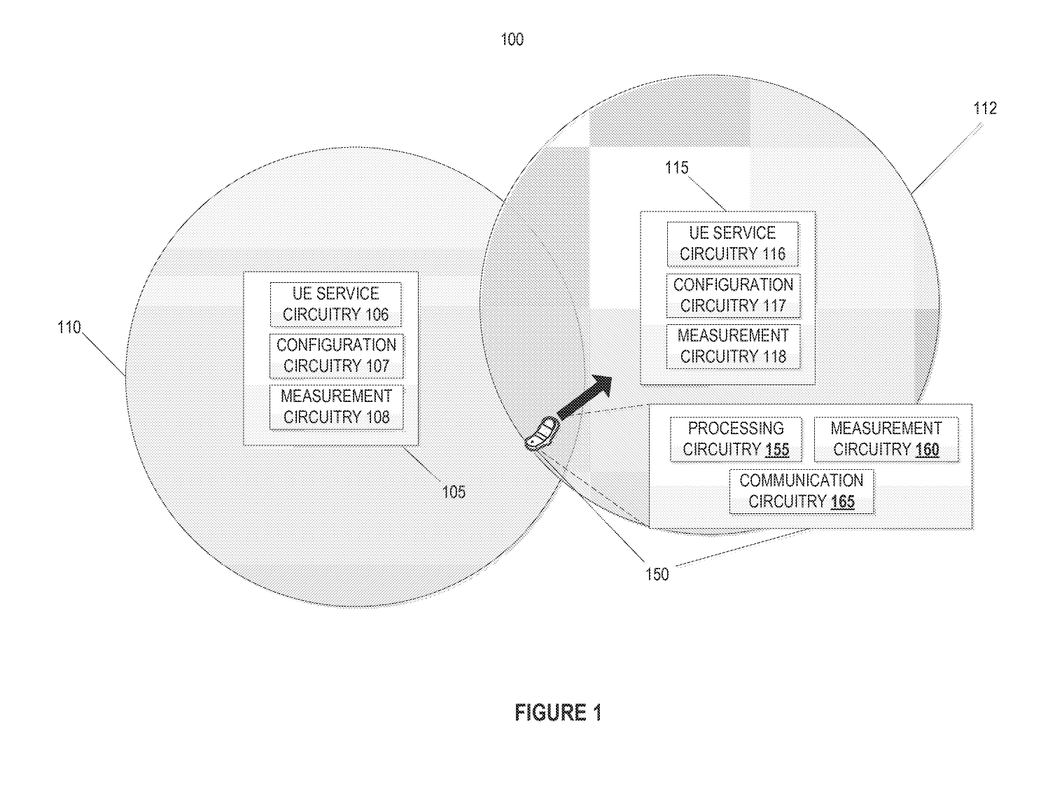

FIG. 1 illustrates an exemplary wireless communication network 100, according to one embodiment. The wireless communication network 100 (hereinafter network 100) may be an access network of a 3rd Generation Partnership Project (“3GPP”) long-term evolution (LTE) network such as evolved universal terrestrial radio access network (E-UTRAN). The network 100 features, among other elements, two access nodes 105 and 115. Access nodes 105 and 115 may be relatively high-power base stations, such as an evolved Node B (eNB) to provide a wireless macro cell, or may be smaller devices designed to provide a small cell such as a femtocell, picocell, microcell, or essentially any similar cell having a range of about less than two (2) kilometers (km). Access node 105 may provide a first service cell 110, and access node 115 may provide a second service cell 112.

To serve a user equipment (UE) 150 and otherwise administrate and/or manage wireless communication in the network 100, the access node 105 may include UE service circuitry 106, configuration circuitry 107, and measurement circuitry 108. Similarly, access node 115 may include UE service circuitry 116, configuration circuitry 117, and measurement circuitry 118. UE service circuitry 116, configuration circuitry 117, and measurement circuitry 118 may be similar to UE service circuitry 106, configuration circuitry 107, and measurement circuitry 108. UE service circuitry 106, 116 may be adapted to perform various tasks in the network 100, including, but not limited to, providing a wireless cell that is to serve the UE 150, determining Radio Resource Management (RRM) metrics that are to be measured and threshold values for those metrics, and processing data received from the UE 150, such as cell identities (e.g., physical layer cell identities and/or global cell identities) and associated RRM measurements. The configuration circuitries 107, 117 may be adapted to transmit data, such as requests and/or configuration information including RLF parameters, to the UE 150 as well as to receive data, such as UE information and configuration data, from the UE 150. Measurement circuitries 108, 118 may be adapted to receive measurement reports from the UE 150 and process such measurement reports to control handover processes.

In the network 100, the UE 150 may connect with the access node 105 when the UE 150 is within the service cell 110. The UE 150 may be any device adapted to connect with the access node 105 according to, for example, the 3GPP specification, such as a hand-held telephone, a laptop computer, or another similar device equipped with a mobile broadband adapter. According to some embodiments, the UE 150 may be adapted to administrate one or more tasks in the network 100, including RLF management, mobility management, call control, session management, and identity management.

To process data and communicate with the access nodes 105 and/or 115, or otherwise function in the network 100, the UE 150 may include, but is not limited to, processing circuitry 155, measurement circuitry 160, and communication circuitry 165. The processing circuitry 155 may be adapted to perform a plurality of tasks for the UE 150, such as detecting physical signals (e.g., primary synchronization signals, secondary synchronization signals, and/or common reference signals) transmitted by one or both of the access nodes 105 and 115. The processing circuitry 155 may also manage RLF processes. The measurement circuitry 160 may be adapted to measure signal strengths or other signal characteristics of various service cells, such as service cells 110 and/or 112. The communication circuitry 165 may be adapted to receive data, including but not limited to RLF parameters, from a network, such as via access nodes 105 and/or 115.

Access nodes 105, 115 are generally static equipment, and thus it may be necessary for a UE 150 to transition from one access node to another access node to maintain service as the UE changes position. For instance, in FIG. 1, UE 150 may have established a connection with access node 105 while located in service cell 110. In this situation, service cell 110 may be referred to as a serving cell, as it is currently serving UE 150. As indicated by the arrow, UE 150 may be moving from serving cell 110 towards service cell 112. In this situation, service cell 112 may be referred to as a target cell. As UE 150 moves further into the target cell 112, the signals from access node 115 associated with the target cell 112 may become stronger than signals from access node 105 associated with serving cell 110. Traditionally, handover processes are used to seamlessly transfer the UE from the serving cell 110 to the target cell 112. For a variety of reasons, including but not limited to measurement errors and signal penetration in some instances, the handover process may fail resulting in a subsequent RLF process and finally cell reselection in order for UE 150 to establish service with the target cell 112. In some instances, RLF may occur independently from a handover failure because different criteria may be relied upon to trigger handover and RLF processes.

Analysis of handover occurrences shows that almost all successful handovers occur when the difference between the target cell signal and serving cell signal is 10 decibels (dB). Similar data also suggests that approximately 90% of handover failures occur when the difference between the target cell signal and serving cell signal is 5 dB or more. Based on this information, setting the threshold for a rapid RLF process, as discussed below, at 10 dB may limit the impact of the rapid RLF process to situations where handover failure is almost a certainty. Lower threshold values may be used with the understanding that in some instances, the rapid RLF process may result in RLF and reconnection where a successful handover might have occurred. For instance, setting the threshold at 5 dB would allow rapid RLF processes to facilitate RLF and reconnection in approximately 90% of situations that would have resulted in handover failure, but will in some instance result in RLF and reconnection where handover may have been successful.

As will be discussed below, both the handover and RLF processes involve timers which may be required to expire before certain actions are initiated. Generally, these timers allow the UE to verify that the signals from the serving and target cells are steady and meet certain trigger event requirements to ensure proper handover and/or to avoid unnecessarily declaring RLF. The timers, however, may also increase service outage time when a handover process fails or when RLF occurs. As will be discussed in more detail below, by terminating or shortening timers, in some instances, it may be possible to minimize service outage time when data suggests that a handover failure or RLF is likely to occur.

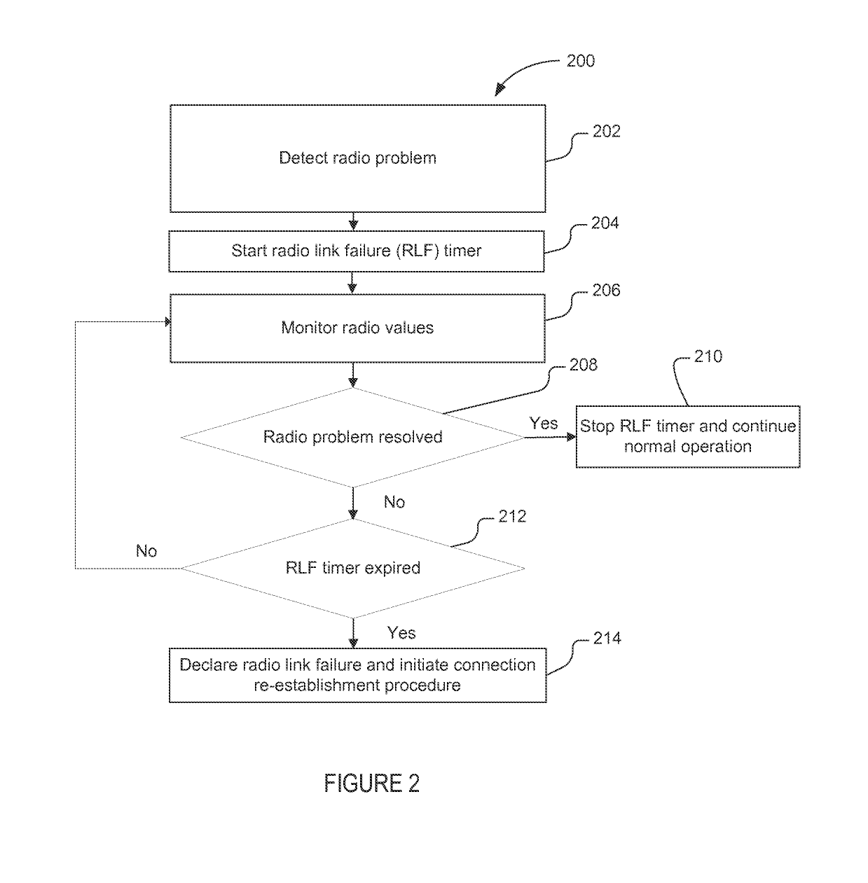

FIG. 2 illustrates an RLF process 200 for use within a UE. The RLF process 200 may start at 202 when the UE detects a radio problem. The radio problem may represent a number of issues, including but not limited to physical layer problems or reaching a maximum number of retransmission attempts. In some embodiments, this may include receiving a 3GPP LTE N310 out of sync indication.

The RLF process 200 may continue at 204 by the UE starting an RLF timer. In some embodiments, the RLF timer may be a 3GPP LTE T310 timer. As discussed in more detail below the RLF timer provides a period of time during which the UE may monitor radio characteristics prior to declaring RLF. In this manner, if the radio problem is resolved prior to the expiration of the RLF timer, the UE may continue to operate normally without experiencing RLF or requiring connection re-establishment.

The RLF process 200 may continue at 206 by the UE monitoring radio values. This may include gathering data from the network to evaluate current signal characteristics.

The RLF process 200 may then continue at 208 by determining if the RLF problem has been resolved. This may include manipulating data gathered during the monitoring operation 206 to determine if the radio problem still exists. This may also include determining if another radio problem is present that is different from the original radio problem detected at 202. If the radio problem has been resolved, the RLF process 200 may continue at 210 where the UE may stop the RLF timer and continue normal operation.

If the radio problem has not been resolved at 208 the process may continue to 212, where the UE may determine if the RLF timer has expired. In addition to determining that the radio problem has not been resolved, operation 208 may alternatively, or additionally, include detecting a new radio problem different from the originally detected radio problem. If a new radio problem is detected, the UE may continue to process 212. In one embodiment, when the UE determines that the original radio problem has been resolved, but that a different radio problem now exists, the UE may return to process 204 to restart the RLF timer.

If the UE determines, at 212, that the RLF timer has not expired, it may return to operation 206. As such, the UE may repeat operations 206, 208, and 212 until either the radio problem is resolved or the RLF timer expires. In this manner, the RLF timer provides a time during which the UE may monitor radio characteristics and return to normal operation if the radio problem is resolved prior to the expiration of the RLF timer.

If the UE determines, at 212, that the RLF timer has expired, the RLF process 200 may continue at 214, where the UE may declare RLF and initiate connection re-establishment procedures. Thus, operation 214 may occur when the radio problem persists beyond the time limit set by the RLF timer. One advantage of the RLF processes discussed below is that the RLF timer may be shortened or terminated earlier in instances where the UE is able to determine that RLF is probable. In some embodiments, a shortened RLF timer may run simultaneously with a traditional RLF timer, as opposed to shortening an existing timer. In doing so, the UE may be able to initiate the connection re-establishment procedures more rapidly and decrease system outage time associated with radio problems that the UE is able to determine are likely to lead to RLF.

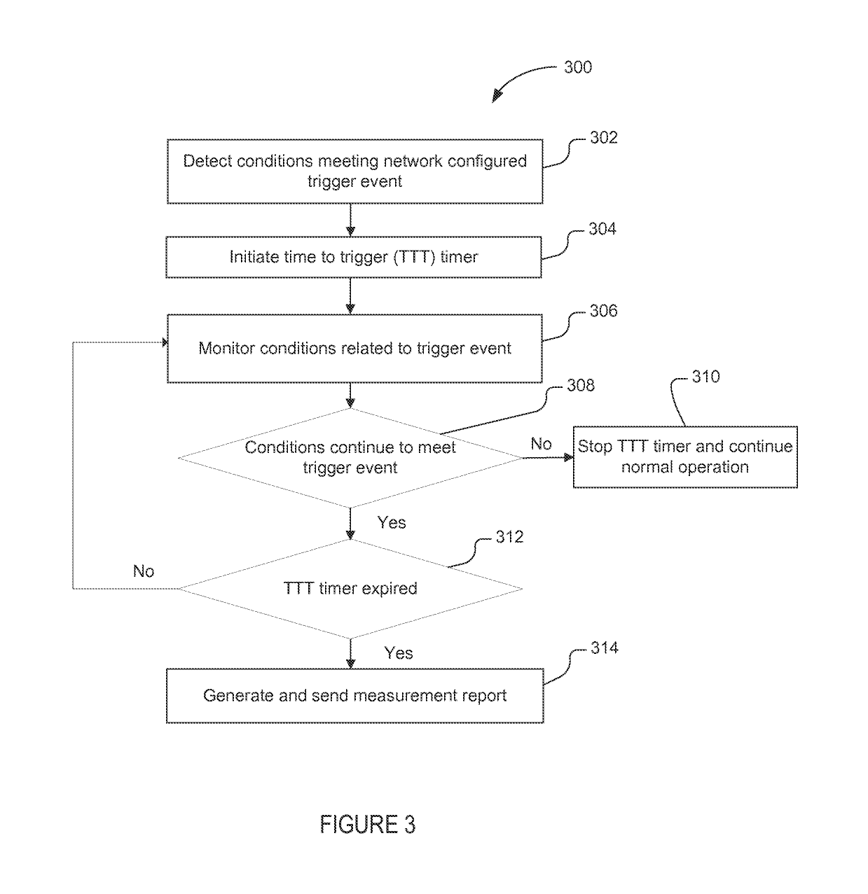

FIG. 3 illustrates a measurement trigger process 300 for use within a UE. The measurement trigger process may determine when the UE will generate and send a measurement report to facilitate a handover process to be controlled by the network. The measurement trigger process 300 may start at 302 when the UE detects conditions meeting a network configured trigger event. The trigger event may represent a number of parameters, including but not limited to a comparison of signal characteristics for a serving cell to those for a target cell. In some embodiments, this may include detecting a 3GPP LTE event indicating a target cell signal has become better than the serving cell signal by at least an offset value (“A3 event”). The criteria for the trigger event may be provided to the UE by the network as part of a measurement object or another communication.

The measurement trigger process 300 may continue at 304, by the UE initiating a time-to-trigger (TTT) timer. In some embodiments the handover timer may be a 3GPP LTE time-to-trigger (TTT) timer. Similar to the RLF timer discussed above, the TTT timer provides a period of time during which the UE may monitor conditions related to the trigger event prior to triggering a measurement report. In this manner, if the conditions no longer satisfy the trigger event (meaning, for instance, that the event criteria are no longer present) prior to the expiration of the TTT timer, the UE may continue to operate normally without completing the triggering a measurement report and proceeding with handover to a target cell.

The measurement trigger process 300 may continue at 306, by the UE monitoring conditions related to the trigger event. This may include gathering data from the network, or multiple access nodes (such as an access node associated with a serving cell and an access node associated with a target cell) to evaluate whether the conditions that initiated the trigger event still exist. In some embodiments, this may include monitoring parameters used to trigger a 3GPP LTE A3 event.

The measurement trigger process 300 may then continue at 308, by determining if the conditions continue to meet the trigger event. This may include manipulating data gathered during the monitoring operation 306 to determine if the trigger event conditions still exist. In some embodiments, this may include monitoring a 3GPP LTE A3 event and determining if it is still active. If the conditions no longer satisfy the trigger event, the measurement trigger process 300 may continue at 310 by stopping the TTT timer and continuing normal operation.

If the conditions continue to satisfy the trigger event at 308 the process 300 may continue to 312, where the UE may determine if the TTT timer has expired. If the UE determines, at 312, that the TTT timer has not expired it may return to operation 306. As such, the UE may repeat operations 306, 308, and 312 until either the conditions no longer satisfy the trigger eventor the TTT timer expires. In this manner the TTT timer provides a time during which the UE may monitor conditions and return to normal operation if the conditions no longer satisfy the trigger event prior to the expiration of the TTT timer.

If the UE determines, at 312, that the TTT timer has expired, the measurement trigger process 300 may continue at 314 where the UE may generate and send a measurement report. Thus, operation 314 may occur when the condition continue to satisfy the trigger event beyond the time limit set by the TTT timer. Upon receiving the measurement report, network resources, such as an access node, may send a handover command to the UE to trigger handover from a serving cell to a target cell.

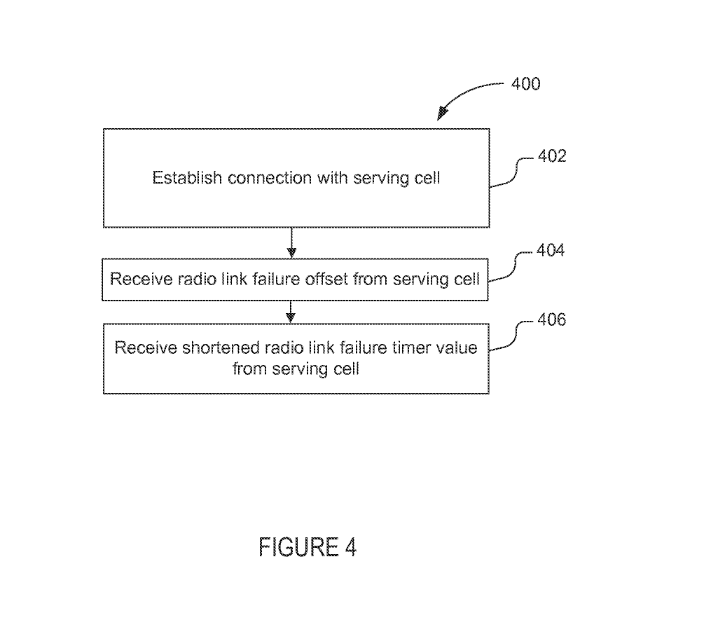

FIG. 4 illustrates a network connection process 400 by which a UE may connect to a network via an access node. The process 400 may begin at 402 when the UE establishes a connection to a serving cell. This may include transmitting data to, and receiving data from, an access node associated with the serving cell to establish a radio connection to the serving cell. This may occur when the UE is initially powered on or enters the serving cell. It may also occur when the UE is handed over from a serving cell to a target cell. Process 400 may occur only during initial network connection or may alternatively occur more frequently when establishing a connection with a different access node of the same network.

The process 400 may continue at 404, where the UE may receive a RLF offset value from the serving cell. The RLF offset value may be configured by the network and may indicate a difference between a signal strength associated with a target cell as compared to a signal strength associated with a serving cell that is required to initiate a rapid RLF process as discussed below. In some embodiments, the RLF offset value may be included in an information element received by the UE from an access node. In some embodiments, the information element may be a ReportConfigEUTRA information element according to the 3GPP LTE specification, which may be sent to the UE when establishing a connection to an access node. The ReportConfigEUTRA information element may include a plurality of parameters for use by the UE in determining when to initiate handover processes or RLF processes. In some embodiments, the RLF offset value in the ReportConfigEUTRA information element may be an integer value between −30 and 30. In some embodiments, the RLF offset value may be in other formats or have different limits.

The process 400 may continue at 406, where the UE may receive a shortened RLF timer value from the serving cell. The shortened RLF timer value may be configured by the network and may be used during later rapid RLF processes as discussed below. As such, process 400 may allow the network to configure parameters relating to rapid RLF processes to be carried out by the UE, when the UE initially establishes a connection with the network. Similar to the RLF offset value discussed above, the shortened RLF timer value may also be included in an information element received by the UE from an access node. In some embodiments, the information element may be a ReportConfigEUTRA information element, which may be sent to the UE when establishing a connection to an access node. In some embodiments, the information element may include both an RLF offset value and a shortened RLF timer value.

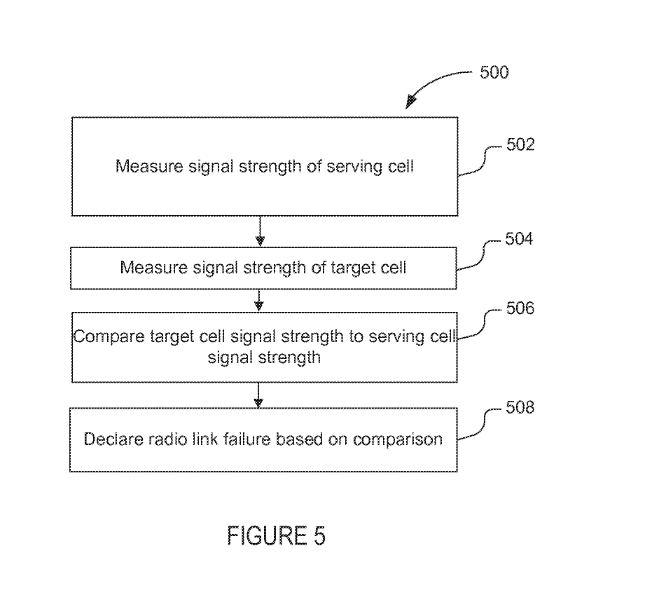

FIG. 5 illustrates a rapid RLF process 500 in accordance with some embodiments. The rapid RLF process 500 may begin at 502 when the UE measures the signal strength of the serving cell. This may include measuring a reference signal received power (RSRP) value or another signal strength value.

The rapid RLF process 500 may continue at 504 when the UE measures the signal strength of a target cell. This may include measuring an RSRP value or another signal strength value.

The rapid RLF process 500 may continue at 506 when the UE compares the target cell signal strength to the serving cell signal strength. This may include determining whether the target cell signal strength exceeds the serving cell signal strength by a threshold value. The threshold value may be an RLF offset value as discussed previously.

The rapid RLF process 500 may continue at 508 when the UE declares RLF based at least in part on the comparison. This may include terminating a previously started RLF timer. In some embodiments, declaring RLF may include terminating a 3GPP LTE T310 timer that is running on the UE. In some embodiments, this may include declaring RLF, although an RLF timer has not been previously triggered. In some embodiments, declaring RLF may trigger a connection re-establishment procedure. By declaring RLF prior to the expiration of the RLF timer, the UE may more rapidly start a connection re-establishment process to connect to a target cell. In this manner, by configuring the parameters used for the comparison process 506, it may be possible to more rapidly declare

RLF and re-establish connection in situations where the radio problems are unlikely to be resolved. Therefore, if the UE is experiencing a service outage due to the radio problems, the system outage time may be decreased by more rapidly declaring RLF and initiating a connection re-establishment process.

In some embodiments, prior to declaring RLF, the UE may determine that a measurement trigger process (such as measurement trigger process 300) has been started. This may include determining that a UE has determined that conditions satisfy a trigger event such as discussed above with reference to FIG. 3(such as 3GPP LTE A3 event as discussed above). In this situation, the UE may terminate a time-to-trigger timer and initiate the generation and transmission of a measurement report prior to declaring RLF. By doing this, the UE may cancel the measurement trigger event, but still provide measurement data to the network (such as an access node associated with the serving cell). In this way, the serving cell may be able to provide information regarding the UE to the target cell even though a traditional handover is not possible. This may allow the target cell to prepare to serve the UE if the UE establishes a connection to the target cell during the connection re-establishment process. Process 500 may be repeated periodically or may be triggered when other events occur. In some embodiments, process 500 maybe initiated when either an RLF process, such as process 200, or a measurement trigger process, such as process 300, is initiated.

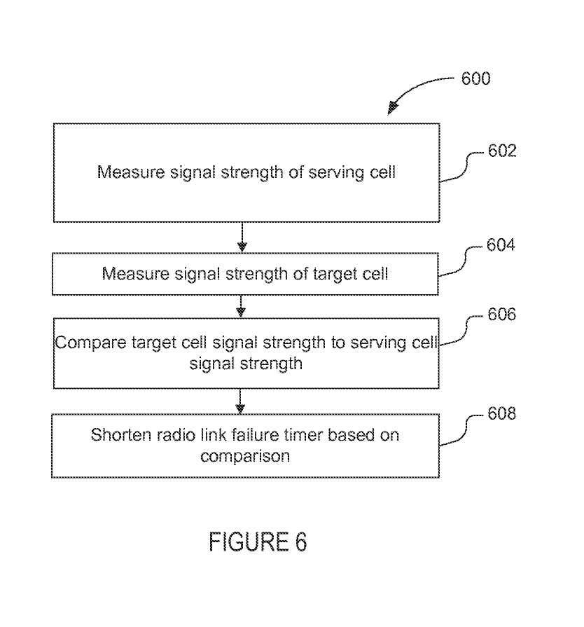

FIG. 6 illustrates a rapid RLF process 600 in accordance with some embodiments. The rapid RLF process 600 may be similar to rapid RLF process 500, but uses a shortened RLF timer as opposed to declaring RLF. The rapid RLF process 600 may begin at 602 when the UE measures the signal strength of the serving cell. This may include measuring an RSRP value or another signal strength value.

The rapid RLF process 600 may continue at 604 when the UE measures the signal strength of a target cell. This may include measuring an RSRP value or another signal strength value.

The rapid RLF process 600 may continue at 606 when the UE compares the target cell signal strength to the serving cell signal strength. This may include determining whether the target cell signal strength exceeds the serving cell signal strength by a threshold value. The threshold value may be an RLF offset value as discussed previously.

The rapid RLF process 600 may continue at 608 when the UE shortens an RLF timer based at least in part on the comparison. In some embodiments, this may include shortening a 3GPP LTE T310 timer that is running on the UE. In some embodiments, this may include replacing the remaining time on an RLF timer with a shortened RLF timer value. In some embodiments, this may include using a second short RLF timer running in parallel with the traditional RLF timer such that RLF may be based on whichever timer expires first. The shortened RLF timer value (or the second short RLF timer value) may be received from the network as discussed previously with reference to FIG. 4. In some embodiments, the UE may determine that the time remaining on the RLF timer is greater than the shortened RLF timer value prior to replacing the running RLF timer with the shortened RLF timer value. In doing such, the UE may be able to prevent the rapid RLF process from inadvertently delaying an RLF determination when the remaining time of the RLF timer is less than the shortened RLF timer value. Process 600 may be repeated periodically or triggered by other events as discussed above with reference to process 500.

By shortening the RLF timer or using the second timer, the process 600 may speed up RLF and associated connection re-establishment processes, while still allowing conditions to improve to prevent RLF or allowing a traditional handover to occur prior to RLF. In this manner, shortening the RLF timer via process 600 may provide a less drastic measure than declaring RLF via process 500. Either process may be used independently, but it may also be possible to use both processes (500 and 600) simultaneously. For instance, in some embodiments, process 600 may be associated with a lower threshold than process 500 such that a first comparison of signal strengths meeting the lower threshold would result in a shortening of the RLF timer, while allowing for immediate declaration of RLF if the higher threshold is met before the shortened RLF timer expires. As such, when used in combination, processes 500 and 600 may provide escalating actions in response to increased differences between target cell signal strength and serving cell signal strength.

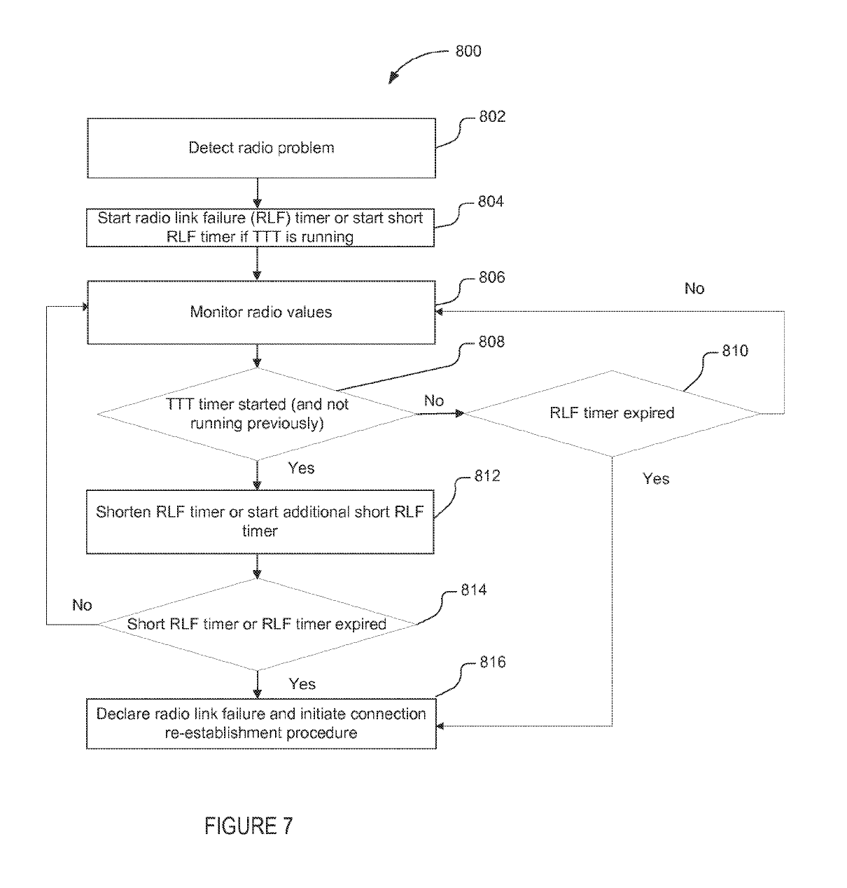

FIG. 7 illustrates a rapid RLF process 800 in accordance with some embodiments. Unlike processes 500 and 600 discussed above, process 800 relies on the start of the TTT timer to modify the RLF characteristics as opposed to relying directly on measured signal characteristics.

The process 800 may begin at 802 when a UE detects a radio problem. This may be similar to operation 202 of process 200 discussed previously. The process 800 may continue at 804 when the UE starts an RLF timer. This may be similar to operation 204 of process 200 discussed previously. This may include determining if a TTT timer is currently running. If the TTT timer is running when the radio problem is detected at 802, the UE may start the RLF timer with a shortened value. In some embodiments, the UE may decrease the starting value for the RLF timer prior to starting the RLF timer if the TTT timer is running when the radio problem is detected. In some embodiments, the UE may start a different short RLF timer, instead of the standard RLF timer, if the TTT timer is running when the radio problem is detected.

The process 800 may continue at 806 when the UE may monitor radio values. This may include verifying that the radio problem detected at 802 continues to exist. As discussed previously with reference to FIG. 2, the UE may be able to stop the RLF timer and continue normal operation if the radio problem is resolved prior to the RLF timer expiring.

The process 800 may continue at 808 when the UE determines if a TTT timer has started. If the TTT timer has not started (or is not running) the process 800 may continue at 810 where the UE may determine if the RLF timer has expired. If the RLF timer has not expired the UE may return to operation 806. In this manner, operations 806, 808, and 810 may be repeated until the radio problem is resolved, the TTT timer is started, or the RLF timer expires. If the RLF timer has expired at 810 the process 800 may continue at 816 where the UE declares RLF and initiates connection re-establishment procedures. If the TTT timer is running when the radio problem is detected, operation 808 may be skipped and the UE may monitor radio values until the RLF (which may be a shortened or alternate RLF timer as discussed above) expires or the radio problem is resolved. In this manner, when the TTT timer is running when the UE detects the radio problem at 802, the process may include repeating operations 806 and 810 until either the radio problem is resolved or the RLF timer (which, as discussed above, is a shortened or alternate RLF timer in this instance) expires.

If at 808 the UE determines that the TTT timer has started (meaning the TTT was not running when the radio problem was detected at 802, but has subsequently started running), the process 800 may continue at 812 where the UE may either shorten the currently running RLF timer or start an additional short RLF timer. Where an additional short RLF timer is used the starting value of the additional short RLF timer may be less than the starting value of the RLF timer related to operation 804. The value of the additional short RLF timer may be set according to criteria received by the UE from the network, as discussed with reference to FIG. 4. In some embodiments, the value of the additional short RLF timer may a predetermined value associated with the UE. In this manner, it is the starting of the TTT timer that results in the change to the RLF parameters (shortening of RLF timer or starting additional short RLF timer) as opposed to direct measurement of signal characteristics.

The process may continue at 814 where the UE determines if the RLF timer or the short RLF timer has expired. If either timer has expired, the process 800 may continue at 816 where the UE declares RLF and initiates connection re-establishment procedures. If neither timer has expired, the process may return to 806. In this manner, once the TTT timer has started, operations 806, 808, 812, and 814 may be repeated until the radio problem no longer exists, or either timer expires. By triggering the shortening of the RLF timer or the initiation of the additional short RLF timer based on the start of the TTT timer it may be possible to decrease the time prior to RLF and connection re-establishment without requiring additional information from the network. In this manner, connection re-establishment may occur more rapidly without changing information elements or other network settings to provide specific criteria to a UE.

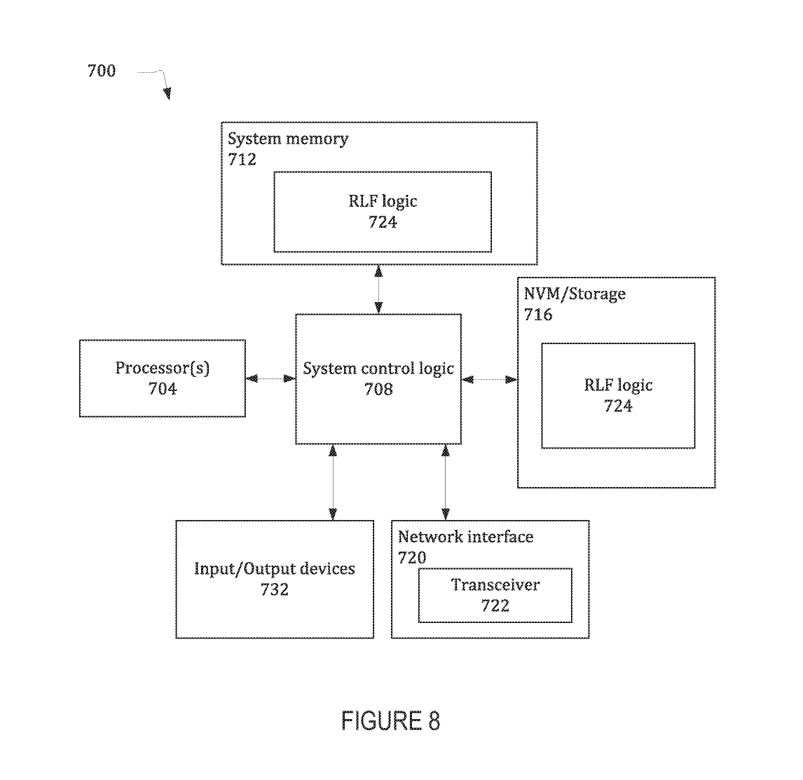

The various circuitry and related functionality described herein may be implemented into a system using any suitable hardware and/or software to configure as desired. FIG. 8 illustrates, for one embodiment, an example system 700 comprising one or more processor(s) 704, system control logic 708 coupled with at least one of the processor(s) 704, system memory 712 coupled with system control logic 708, non-volatile memory (NVM)/storage 716 coupled with system control logic 708, a network interface 720 coupled with system control logic 708, and input/output (I/O) devices 732 coupled with system control logic 708.

The processor(s) 704 may include one or more single-core or multi-core processors. The processor(s) 704 may include any combination of general-purpose processors and dedicated processors (e.g., graphics processors, application processors, baseband processors, etc.). Processor(s) 704 may incorporate an applications processor, a graphics processor, and a modem (such as an LTE modem) or any combination of such elements. For instance, in some embodiments, processor(s) 704 may include an integrated applications processor and LTE modem. In one embodiment, processor(s) 704 may be an Intel® XMM™ 7160 chip.

System control logic 708 for one embodiment may include any suitable interface controllers to provide for any suitable interface to at least one of the processor(s) 704 and/or to any suitable device or component in communication with system control logic 708.

System control logic 708 for one embodiment may include one or more memory controller(s) to provide an interface to system memory 712. System memory 712 may be used to load and store data and/or instructions, e.g., RLF logic 724. System memory 712 for one embodiment may include any suitable volatile memory, such as suitable dynamic random access memory (DRAM), for example.

NVM/storage 716 may include one or more tangible, non-transitory computer-readable media used to store data and/or instructions, e.g., RLF logic 724. NVM/storage 716 may include any suitable non-volatile memory, such as flash memory, for example, and/or may include any suitable non-volatile storage device(s), such as one or more hard disk drive(s) (HDD(s)), one or more compact disk (CD) drive(s), and/or one or more digital versatile disk (DVD) drive(s), for example.

The NVM/storage 716 may include a storage resource physically part of a device on which the system 700 is installed, or it may be accessible by, but not necessarily a part of, the device. For example, the NVM/storage 716 may be accessed over a network via the network interface 720 and/or over Input/Output (I/O) devices 732.

The RLF logic 724 may include instructions that, when executed by one or more of the processors 704, cause the system 700 to perform operations associated with the components of the various circuitry and processes as described with respect to the above embodiments. In various embodiments, the RLF logic 724 may include hardware, software, and/or firmware components that may or may not be explicitly shown in system 700.

Network interface 720 may have a transceiver 722 to provide a radio interface for system 700 to communicate over one or more network(s) and/or with any other suitable device. In various embodiments, the transceiver 722 may be integrated with other components of system 700. For example, the transceiver 722 may include a processor of the processor(s) 704, memory of the system memory 712, and NVM/storage of NVM/Storage 716. Network interface 720 may include any suitable hardware and/or firmware. Network interface 720 may include a plurality of antennas to provide a multiple input, multiple output radio interface. Network interface 720 for one embodiment may include, for example, a wired network adapter, a wireless network adapter, a telephone modem, and/or a wireless modem.

For one embodiment, at least one of the processor(s) 704 may be packaged together with logic for one or more controller(s) of system control logic 708. For one embodiment, at least one of the processor(s) 704 may be packaged together with logic for one or more controllers of system control logic 708 to form a System in Package (SiP). For one embodiment, at least one of the processor(s) 704 may be integrated on the same die with logic for one or more controller(s) of system control logic 708. For one embodiment, at least one of the processor(s) 704 may be integrated on the same die with logic for one or more controller(s) of system control logic 708 to form a System on Chip (SoC).

In various embodiments, the I/O devices 732 may include user interfaces designed to enable user interaction with the system 700, peripheral component interfaces designed to enable peripheral component interaction with the system 700, and/or sensors designed to determine environmental conditions and/or location information related to the system 700.

In various embodiments, the user interfaces could include, but are not limited to, a display (e.g., a liquid crystal display, a touch screen display, etc.), speakers, a microphone, one or more cameras (e.g., a still camera and/or a video camera), a flashlight (e.g., a light emitting diode flash), and a keyboard.

In various embodiments, the peripheral component interfaces may include, but are not limited to, a non-volatile memory port, a universal serial bus (USB) port, an audio jack, an Ethernet connection, and a power supply interface.

In various embodiments, the sensors may include, but are not limited to, a gyro sensor, an accelerometer, a proximity sensor, an ambient light sensor, and a positioning unit.

In various embodiments, the system 700 may be a mobile computing device such as, but not limited to, a laptop computing device, a tablet computing device, a netbook, a smartphone, etc. In various embodiments, system 700 may have more or less components, and/or different architectures.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims and the equivalents thereof.

Various embodiments may include any suitable combination of the above-described embodiments including alternative (or) embodiments of embodiments that are described in conjunctive form (and) above (e.g., the “and” may be “and/or”). Furthermore, some embodiments may include one or more articles of manufacture (e.g., non-transitory computer-readable media) having instructions, stored thereon, that when executed, result in actions of any of the above-described embodiments. Moreover, some embodiments may include apparatuses or systems having any suitable means for carrying out the various operations of the above-described embodiments.

The above description of illustrated implementations, including what is described in the Abstract, is not intended to be exhaustive or to limit the embodiments of the present disclosure to the precise forms disclosed. While specific implementations and examples are described herein for illustrative purposes, various equivalent modifications are possible within the scope of the present disclosure, as those skilled in the relevant art will recognize.

These modifications may be made to embodiments of the present disclosure in light of the above detailed description. The terms used in the following claims should not be construed to limit various embodiments of the present disclosure to the specific implementations disclosed in the specification and the claims. Rather, the scope is to be determined entirely by the following claims, which are to be construed in accordance with established doctrines of claim interpretation.

### EXAMPLES

Some non-limiting examples are provided below.

Example 1 includes an apparatus to be implemented in a user equipment (UE), the apparatus comprising: measurement circuitry to: measure a signal strength of a serving cell; and measure a signal strength of a target cell; and processing circuitry to: compare the signal strength of the serving cell to the signal strength of the target cell; and declare radio link failure (RLF) based at least in part on the comparison.

Example 2 includes the apparatus of example 1, wherein the signal strengths of the serving cell and the target cell are reference signal received power (RSRP) values.

Example 3 includes the apparatus of example 1, further comprising communication circuitry to receive an RLF offset value from a network.

Example 4 includes the apparatus of example 3, wherein the processing circuitry is further to: determine that the signal strength of the target cell exceeds the signal strength of the serving cell by at least the RLF offset value; and declare RLF based at least in part on the determination.

Example 5 includes the apparatus of any of examples 1-4, wherein declaring RLF includes terminating a previously started timer.

Example 6 includes the apparatus of example 5, wherein the previously started timer is a 3^{rd} Generation Partnership Project (3GPP) Long Term Evolution (LTE) T310 timer.

Example 7 includes the apparatus of any of examples 1-4, wherein the processing circuitry is further to: determine that a UE measurement trigger event has occurred; terminate a UE measurement trigger timer based at least in part on the comparison; and instruct transceiver circuitry to send a measurement report to the serving cell prior to declaring RLF.

Example 8 includes one or more tangible computer-readable media having instructions, stored thereon, that when executed cause a user equipment (UE) to: measure a signal strength of a serving cell; measure a signal strength of a target cell; compare the signal strength of the serving cell to the signal strength of the target cell; and shorten a radio link failure (RLF) timer based on the comparison.

Example 9 includes the one or more media of example 8, wherein the instructions, when executed, cause the UE to receive an RLF offset value from a network.

Example 10 includes the one or more media of example 9, wherein the instructions, when executed, cause the UE to determine if the signal strength of the target cell exceeds the signal strength of the serving cell by at least the RLF offset value.

Example 11 includes one or more media of example 8, wherein the instructions, when executed, cause the UE to receive a shortened RLF timer value from a network.

Example 12 includes the one or more media of example 11, wherein the instructions, when executed, cause the UE to set the RLF timer to the shortened RLF timer value.

Example 13 includes the one or more media of example 12, wherein the instructions, when executed, cause the UE to determine that the value of the RLF timer is greater than the shortened RLF timer value before setting the RLF timer to the shortened RLF timer value.

Example 14 includes the one or more media of any of examples 8-13, wherein the RLF timer is a 3^{rd} Generation Partnership Project (3GPP) Long Term Evolution (LTE) T310 timer.

Example 15 includes the one or more media of any of examples 8-13, wherein the instructions, when executed, cause the UE to: determine that a UE measurement trigger event has occurred; terminate a UE measurement trigger timer based at least in part on the comparison; and instruct transceiver circuitry to send a measurement report to the serving cell.

Example 16 includes an apparatus to be implemented in a user equipment (UE), the apparatus comprising: measurement circuitry to: measure radio characteristics; and processing circuitry to: start a first radio link failure (RLF) timer based at least in part on the measured radio characteristics; determine that a measurement trigger timer has started; and start a second RLF timer based at least in part on the determination that the measurement trigger timer has started.

Example 17 includes the apparatus of example 16, wherein a starting value of the second RLF timer is less than a starting value of the first RLF timer.

Example 18 includes the apparatus of example 16, wherein the first RLF timer is a 3^{rd} Generation Partnership Project (3GPP) Long Term Evolution (LTE) T310 timer.

Example 19 includes the apparatus of example 16, wherein the measurement trigger timer is a 3^{rd} Generation Partnership Project (3GPP) Long Term Evolution (LTE) time-to-trigger (TTT) timer.

Example 20 includes the apparatus of example 16, wherein the processing circuitry is further to declare RLF upon the earliest of an expiration of the first RLF timer or an expiration the second RLF timer.

Example 21 includes an apparatus to be implemented in an evolved Node B (eNB), the apparatus comprising: user equipment (UE) service circuitry to establish and provide cellular service to a UE; measurement circuitry to receive a measurement report from the UE; and configuration circuitry to send at least one fast radio link failure (RLF) parameter to the UE; wherein the fast RLF parameter includes at least one of an offset value or a timer value.

Example 22 includes the apparatus of example 21, wherein the fast RLF parameter is an RLF offset value.

Example 23 includes the apparatus of example 21, wherein the fast RLF parameter is a shortened RLF timer value.

Example 24 includes the apparatus of any of examples 21-23, wherein the configuration circuitry is to send the UE both an RLF offset value and a shortened RLF timer value when establishing service for the UE.

Example 25 includes the apparatus of any of examples 21-23, further comprising communication circuitry to send information regarding the UE to a target cell based at least in part on the measurement report.

1. An apparatus to be implemented in a user equipment (UE), the apparatus comprising:
measurement circuitry to:
measure a signal strength of a serving cell; and
measure a signal strength of a target cell; and
processing circuitry to:
compare the signal strength of the serving cell to the signal strength of the target cell; and
declare radio link failure (RLF) based at least in part on the comparison.

2. The apparatus of claim 1, wherein the signal strengths of the serving cell and the target cell are reference signal received power (RSRP) values.

3. The apparatus of claim 1, further comprising communication circuitry to receive an RLF offset value from a network.

4. The apparatus of claim 3, wherein the processing circuitry is further to:
determine that the signal strength of the target cell exceeds the signal strength of the serving cell by at least the RLF offset value; and
declare RLF based at least in part on the determination.

5. The apparatus of claim 1, wherein declaring RLF includes terminating a previously started timer.

6. The apparatus of claim 5, wherein the previously started timer is a 3rd Generation Partnership Project (3GPP) Long Term Evolution (LTE) T310 timer.

7. The apparatus of claim 1, wherein the processing circuitry is further to:
determine that a UE measurement trigger event has occurred;
terminate a UE measurement trigger timer based at least in part on the comparison; and
instruct transceiver circuitry to send a measurement report to the serving cell prior to declaring RLF.

8. One or more tangible computer-readable media having instructions, stored thereon, that when executed, cause a user equipment (UE) to:
measure a signal strength of a serving cell;
measure a signal strength of a target cell;
compare the signal strength of the serving cell to the signal strength of the target cell; and
shorten a radio link failure (RLF) timer based on the comparison.

9. The one or more media of claim 8, wherein the instructions, when executed, cause the UE to receive an RLF offset value from a network.

10. The one or more media of claim 9, wherein the instructions, when executed, cause the UE to determine if the signal strength of the target cell exceeds the signal strength of the serving cell by at least the RLF offset value.

11. The one or more media of claim 8, wherein the instructions, when executed, cause the UE to receive a shortened RLF timer value from a network.

12. The one or more media of claim 11, wherein the instructions, when executed, cause the UE to set the RLF timer to the shortened RLF timer value.

13. The one or more media of claim 12, wherein the instructions, when executed, cause the UE to determine that the value of the RLF timer is greater than the shortened RLF timer value before setting the RLF timer to the shortened RLF timer value.

14. The one or more media of claim 8, wherein the RLF timer is a 3rd Generation Partnership Project (3GPP) Long Term Evolution (LTE) T310 timer.

15. The one or more media of claim 8, wherein the instructions, when executed, cause the UE to:
determine that a UE measurement trigger event has occurred;
terminate a UE measurement trigger timer based at least in part on the comparison; and
instruct transceiver circuitry to send a measurement report to the serving cell.

16. An apparatus to be implemented in a user equipment (UE), the apparatus comprising:
measurement circuitry to:
measure radio characteristics; and
processing circuitry to:
start a first radio link failure (RLF) timer based at least in part on the measured radio characteristics;
determine that a measurement trigger timer has started; and
start a second RLF timer based at least in part on the determination that the measurement trigger timer has started.

17. The apparatus of claim 16, wherein a starting value of the second RLF timer is less than a starting value of the first RLF timer.

18. The apparatus of claim 16, wherein the first RLF timer is a 3rd Generation Partnership Project (3GPP) Long Term Evolution (LTE) T310 timer.

19. The apparatus of claim 16, wherein the measurement trigger timer is a 3rd Generation Partnership Project (3GPP) Long Term Evolution (LTE) time-to-trigger (TTT) timer.

20. The apparatus of claim 16, wherein the processing circuitry is further to declare RLF upon the earliest of an expiration of the first RLF timer or an expiration the second RLF timer.

21. An apparatus to be implemented in an evolved Node B (eNB), the apparatus comprising:
user equipment (UE) service circuitry to establish and provide cellular service to a UE;
measurement circuitry to receive a measurement report from the UE; and
configuration circuitry to send at least one fast radio link failure (RLF) parameter to the UE;
wherein the fast RLF parameter includes at least one of an offset value or a timer value.

22. The apparatus of claim 21, wherein the fast RLF parameter is an RLF offset value.

23. The apparatus of claim 21, wherein the fast RLF parameter is a shortened RLF timer value.

24. The apparatus of claim 21, wherein the configuration circuitry is to send the UE both an RLF offset value and a shortened RLF timer value when establishing service for the UE.

25. The apparatus of claim 21, further comprising communication circuitry to send information regarding the UE to a target cell based at least in part on the measurement report.
